(19) United States
(12) Patent Application Publication
(10) Pub. No.: US 2006/0129880 A1
(43) Pub. Date: Jun. 15, 2006

(54) Method and system for injecting faults into a software application

(76) Inventors: Mauro Arcese, Fontana Liri (FR) (IT); Michele D'Urso, Rome (IT); Rosario Gangemi, Roma (IT); Luigi Pichetti, Rome (IT)

Correspondence Address: IBM CORPORATION;INTELLECTUAL PROPERTY LAW, 11400 BURNET ROAD, AUSTIN, TX, 78758, US

(21) Appl. No.: 11/272,518

(22) Filed: Nov. 10, 2005

(30) Foreign Application Priority Data
Nov. 26, 2004 (EP) 04106124.3

(51) Int. Cl. G06F 11/00

(52) U.S. Cl. 714/11

(57) ABSTRACT

A method for testing a software application (225), for example, written in the Java language is proposed. For this purpose, a factory object (230c) can be configured to operate in a production mode or in a test mode. In the test mode, the factory object instantiates a proxy object (255) for each object (235, 240) of the application. In this way, the invocation of each method exposed by any object of the application is intercepted by the corresponding proxy object. The proxy object invokes a specific method on a fault generator object (265), which provides a return code that can simulate desired error conditions (for example, according to a predefined probability). The proxy object then forwards the invocation to the actual object or returns the error code received from the fault generator object. Alternatively, the same result can be achieved by configuring a class loader to operate in the test mode (when necessary); in this case, the class loader updates the definition of the methods of each class directly so as to invoke the method exposed by the fault generator object.

### TECHNICAL FIELD

The present invention relates to the data processing field. More specifically, the present invention relates to the testing of software applications, and particularly to the injection of faults into software applications.

### BACKGROUND ART

The test of software applications is a very critical activity. The object of any test process consists of verifying that each application under analysis operates correctly according to its specifications. This is of the utmost importance for ensuring a high level of quality and reliability of the application.

A particular area of interest relates to the measuring of a fault tolerance (or robustness) of the application. In this case, the application is tested under different error conditions of an environment where the application runs; as a result, it is possible to verify whether the application tolerates perturbations of the environment (for example, due to stress conditions or malicious attacks). However, the implementation of an extensive fault tolerance test is very difficult, since those situations are exceptional and rarely arise during the normal operation of the application.

Several fault injection techniques have been proposed in the last years in an attempt to facilitate the above-mentioned test process. In this case, desired error conditions are induced in the environment (in a controlled manner), so as to allow measuring the corresponding response of the application. For example, the simplest solution is that of injecting the faults by updating the code of the application directly. However, this approach is very time consuming and untenable in most practical situations.

Alternatively, the environment of the application is provided with specific modules for controlling the fault injection process. For example, selected system libraries can be modified to produce desired error conditions when the application calls them. Similar results are achieved by introducing an auxiliary layer between a network protocol and its underlying communication structure. Another approach is based on the definition of scripts that contain sequences of desired faults; a controller interprets each script, which commands are then executed on different computers under the control of corresponding agents.

However, all the solutions described above are quite invasive. In any case, they require a massive definition of specific code for controlling the fault injection process (which validity cannot likewise be guaranteed).

Considering in particular applications written in the Java language, another solution is that of exploiting the Virtual Machine Debug Interface (JVMDI) of the Java Virtual Machine (JVM). This interface allows defining breakpoints in the execution of each application (where desired faults can be injected). However, the debug interface is not standard and is provided by some virtual machines only; therefore, the above-described solution is not of general applicability. Moreover, this approach interferes with the execution of the application; indeed, the debug interface disables the run-time optimizations of the virtual machine, so that it is impossible to test the application in its actual production environment.

In any case, with the available solutions it is hard (if not impossible) to trigger certain error conditions; Particularly, the problem is more evident when the error conditions must occur at specific locations of the application. Moreover, the above-described techniques often require a deep knowledge of the environment where the application runs (to allow its correct set up for the test process).

### SUMMARY OF THE INVENTION

According to the present invention, the idea of intercepting the invocation of desired methods for simulating error conditions is suggested.

Particularly, an aspect of the invention provides a process for testing a software application; the application includes a plurality of objects (each one exposing one or more methods). The process at first involves selecting a production mode or a test mode of the application. In the test mode, a corresponding auxiliary method is enabled in substitution of at least one selected method. In this way, in response to the invocation of each method, the same method is executed; on the other hand, in response to the invocation of each auxiliary method, the corresponding selected method is executed or an error condition is simulated according to a predefined policy.

The proposed solution is highly configurable and can be enabled on-demand at any moment (while it does not affect the application behavior when disabled); for example, it is possible to test the application directly in its real production environment.

This process is not invasive. Particularly, the process only requires minimal modifications and does not need any massive code definition for its implementation.

Nevertheless, the devised solution allows simulating whatever error conditions at any desired location; it should be noted that this result is achieved without requiring a deep knowledge of the environment where the application runs.

As a consequence, it is possible to facilitate the verification of the robustness of the application, thereby improving its quality and reliability.

The different embodiments of the invention described in the following provide additional advantages.

For example, a suggested implementation of the auxiliary methods involves the invocation of a generation method that is exposed by a fault generator object.

This choice strongly simplifies the embedding of the proposed functionality into the application.

As a further enhancement, a handler object is used to filter the invocation of the generation method (according to a further predefined policy).

The proposed additional feature allows selecting the desired methods to be instrumented for the test in a very simple manner.

In a specific embodiment of the invention, each method is updated by a class loader directly (to implement the corresponding auxiliary method).

In this way, it is possible to create the auxiliary methods automatically at run-time (without any manual intervention); moreover, this solution does not require any modification to the application, so that it is of general applicability.

In a different embodiment of the invention, a factory object instantiates a proxy object for each object that implements one or more predefined interfaces; the proxy object redefines each method declared by the interfaces so as to implement the corresponding auxiliary method.

This approach allows creating each auxiliary method automatically at run-time as well; moreover, in this case the solution is completely embedded into the application, so that it is immediately applicable in any environment.

As a further enhancement, the factory object instantiates a predefined wrapper object for each object that exposes one or more selected methods (but that does not implement any interface); the wrapper object extends the object by redefining each selected method to implement the corresponding auxiliary method.

In this way, even the classes that do not implement any interface can be instrumented for the test (provided that the corresponding wrapper objects are defined statically).

Advantageously, the policy is based on state information of the application.

Therefore, it is possible to trigger the injection of the faults in specific situations.

In addition or in alternative, the policy is based on a predefined probability of the error condition.

As a result, desired statistics patterns can be implemented.

A further aspect of the present invention provides a computer program for performing the above-described process.

A still further aspect of the invention provides a program product embodying this computer program.

Another aspect of the invention provides a corresponding data processing system.

The characterizing features of the present invention are set forth in the appended claims. The invention itself, however, as well as further features and advantages thereof will be best understood by reference to the following detailed description, given purely by way of a nonrestrictive indication, to be read in conjunction with the accompanying drawings.

### BRIEF DESCRIPTION OF THE DRAWINGS

FIG. 1a is a schematic block diagram of a computer in which the method according to an embodiment of the invention is applicable;

FIG. 2 depicts the main software components that can be used for practicing the method in a first embodiment of the invention;

FIG. 3 depicts the main software components that can be used for practicing the method in a second embodiment of the invention;

FIGS. 4a-4e show a diagram describing the flow of activities relating to an illustrative implementation of the method according to the first embodiment of the invention; and

FIGS. 5a-5b show a diagram describing the flow of activities relating to an illustrative implementation of the method according to the second embodiment of the invention.

### DETAILED DESCRIPTION OF THE PREFERRED EMBODIMENT(S)

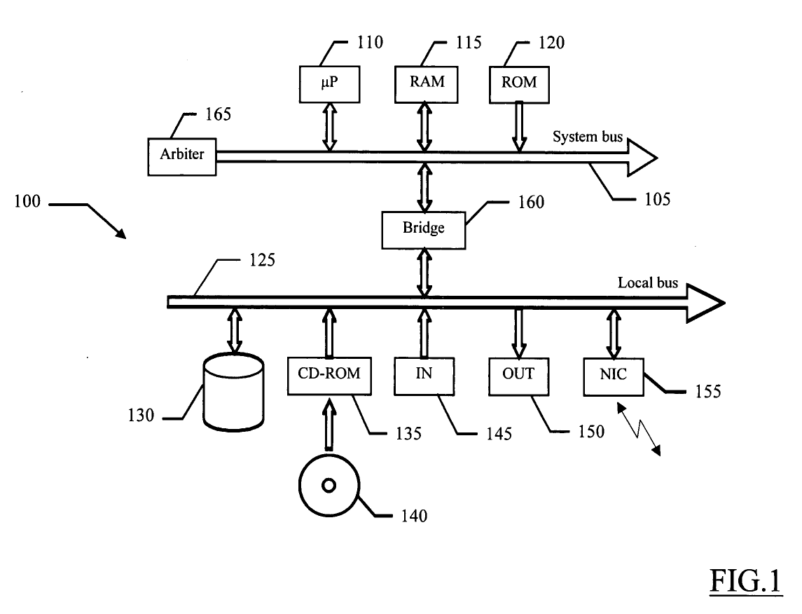

With reference in particular to FIG. 1, a computer 100 (which can be used for implementing the method according to an embodiment of the invention) is shown. The computer 100 (for example, consisting of a PC) is formed by several units that are connected in parallel to a system bus 105. In detail, a microprocessor (μP) 110 controls operation of the computer 100; a 10 RAM 115 is directly used as a working memory by the microprocessor 110, and a ROM 120 stores basic code for a bootstrap of the computer 100. Peripheral units are clustered around a local bus 125 (by means of respective interfaces). Particularly, a mass memory consists of a hard disk 130 and a drive 135 for reading CD-ROMs 140. Moreover, the computer 100 includes input devices 145 (for example, a keyboard and a mouse), and output devices 150 (for example, a monitor and a printer). A Network Interface Card (NIC) 155 is used to connect the computer 100 to a network. A bridge unit 160 interfaces the system bus 105 with the local bus 125. The microprocessor 110 and the bridge unit 160 can operate as master agents requesting an access to the system bus 105 for transmitting information. An arbiter 165 manages the granting of the access with mutual exclusion to the system bus 105.

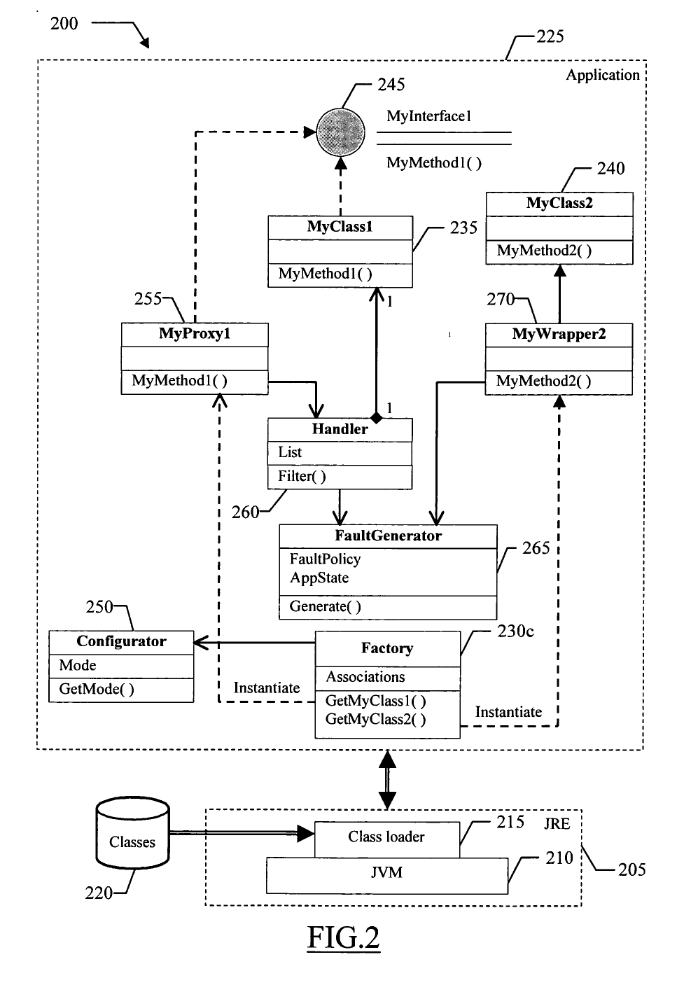

Moving now to FIG. 2, the main software components that can be used for practicing the proposed method (according to a first embodiment of the invention) are denoted as a whole with the reference 200. The information (programs and data) is typically stored on the hard disk and loaded (at least partially) into the working memory of the computer when the programs are running. The programs are initially installed onto the hard disk from CD-ROM.

The computer hosts a Java Runtime Environment (JRE) 205 for running applications written in the Java language. Particularly, the JRE 205 includes a Java Virtual Machine (JVM) 210 that defines a standard execution environment (irrespective of the hardware/software platform of the computer). A class loader 215 on top of the JVM 210 is responsible to load new classes (required by the running applications). The classes consist of template definitions of attributes and methods for different types of objects, which are typically stored in corresponding files (collectively denoted as 220 in the figure). The class loader 215 receives the name of each new class, and attempts to locate data that constitutes its definition (for example, by transforming the name of the new class into the name of a file and then reading the definition of the new class from the file of that name).

An exemplary application running in the JRE 205 is denoted with the reference 225. An overview of the application 225 is illustrated in the figure by means of a corresponding class diagram (showing its classes and the relationships among them). Particularly, the application 225 includes a class Factory 230c, which is used to create any desired object by instantiating the corresponding class. Particularly, the application 225 includes a class MyClass1 235 exposing a method MyMethod1( ), and a class MyClass2 240 exposing a method MyMethod2( ). The class MyClass1 235 implements an interface MyInterface1 245. The interfaces consist of template definitions basically containing the declarations of methods (i.e., only including the specifications of their signatures), which methods are then concretely defined by each class implementing the interfaces; in this case, the interface MyInterface1 245 declares the method MyMethod1( ) that is defined by the class MyClass1 235. The class Factory 230c exposes a method GetMyClass1( ) and a method GetMyClass2( ) for instantiating the class MyClass1 235 and the class MyClass2 240, respectively.

The class Factory 230c is customized so as to be associated with a class Configurator 250. The class Configurator 250 has an attribute Mode, which indicates an operative mode of the application 225 (for example, implemented through a registry key or an environmental variable); a corresponding method GetMode( ) is used to read the current value of the attribute Mode. For example, the attribute Mode is deasserted when the application 225 is configured to run in a production mode and it is asserted when the application 225 is configured to run in a test mode.

In the production mode, the methods GetMyClass1( ) and GetMyClass2( ) directly instantiate the respective classes MyClass1 235 and MyClass2 240 as usual.

Conversely, in the test mode the method GetMyClass1( ) instantiates a class MyProxyl 255, which acts as a proxy between the class Factory 230c and the actual class MyClass1 235. The class MyProxy1 255 implements the same interface MyInterface1 245. Typically, a specific proxy class is associated with each interface (or group of interfaces) that can be instantiated by the different classes of the application 225; this information is available in a corresponding attribute Associations of the class Factory 230c.

The class MyProxy1 255 dynamically redefines any method declared by the corresponding interface MyInterface1 245 (i.e., the method MyMethod1( ) in the example at issue). The method MyMethod1( ) of the class MyProxy1 255 invokes a method Filter( ), by passing the name of the corresponding class MyClass1 and the name of the method MyMethod1 as parameters, which method Filter( ) is exposed by a class Handler 260 containing the class MyClass1 235. The method Filter( ) determines whether the method at issue must be instrumented for the test; this information is available in a corresponding attribute List of the class Handler 260 (for example, implemented with a file that stores a list of the desired methods to be verified).

The class Handler 260 is associated with a class FaultGenerator 265. When the method MyMethod1( ) must be instrumented for the test, the method Filter( ) invokes a method Generate( ) that is exposed by the class FaultGenerator 265 (by passing the name of the class MyClass1 and the name of the method MyMethod1). The method Generate( ) returns a code simulating a result of the execution of the method MyMethod1( ). The return code is obtained according to a predefined policy provided by a corresponding attribute FaultPolicy of the class FaultGenerator 265 (for example, defined by a set of rules stored in a configuration file); preferably, the error policy is based on an aggregated state of the application 225, which is stored in a corresponding attribute AppState of the class FaultGenerator 265.

More in detail, the method Generate( ) normally provides a return code with a pass value (for example, 0); in this case, the class MyProxy1 245 invokes the actual method MyMethod1( ) exposed by the class MyClass1 235. Conversely, the method Generate( ) can provide a return code with an error value, which simulates a desired error condition in the application 225 (for example, a network interruption, a database exception, an unexpected power-off, and the like). For example, the return code always has the pass value when a predefined condition for the injection of the faults is not satisfied (such as, the number of invocations of the method MyMethod1 does not reach a threshold value); conversely, the return code will take a predefined error value according to a corresponding probability.

In this way, the methods exposed by the proxy classes implement (auxiliary) methods that are used to intercept any invocation of the corresponding methods exposed by the actual classes of the application; each auxiliary method then invokes the corresponding method or simulates the desired error condition when required. It should be noted that this result is achieved by building the auxiliary methods automatically at run-time without any manual intervention. Moreover, the proposed solution is completely embedded in the application (and particularly in the class Factory 230c), so that it is immediately applicable in any environment. However, the proposed approach needs that the classes implement one or more interfaces; in addition, this solution is unable to instrument static methods (i.e., methods that do not use instance variables, and then cannot be declared in the interfaces).

Considering again the test mode of operation of the application 225, the method GetMyClass2( ) instantiates a class MyWrapper2 270, which acts as a wrapper for the actual class MyClass2 240. The class MyWrapper2 270 extends the class MyClass2 240 (thereby inheriting its attributes and methods). The class MyWrapper2 270 statically redefines one or more methods exposed by the corresponding class MyClass2 240 (i.e., the method MyMethod2( ) in the example at issue). Particularly, the method MyMethod2( ) is not redefined when it must not be instrumented for the test. Conversely, the method MyMethod2( ) of the class MyWrapper2 270 invokes the method Generate( ) that is exposed by the class FaultGenerator 265 (by passing the name of the class MyClass2 and the name of the method MyMethod2 as parameters); the invocation is then forwarded to the actual method MyMethod2( ) of the class MyClass2 240 if the corresponding return code has the pass value.

With this approach, the wrapper classes are built statically (so that it is possible to instrument the desired classes even if they do not implement any interface). In any case, it should be noted that this solution cannot be used to instrument final classes (i.e., classes that cannot be extended).

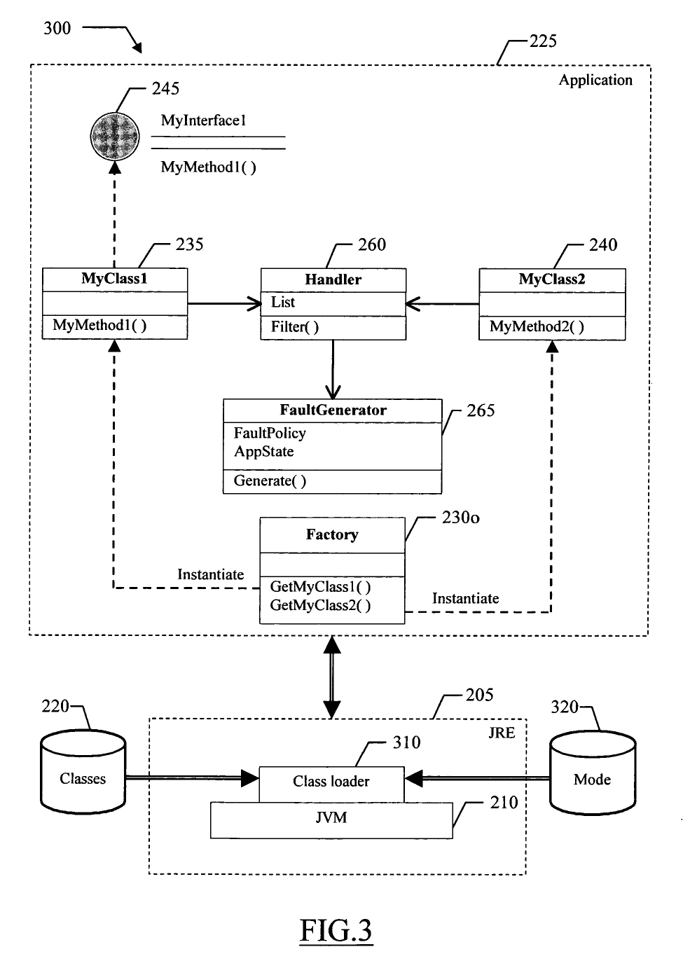

In a different embodiment of the invention, as shown in FIG. 3, the main software components that can be used for practicing the proposed method are denoted as a whole with the reference 300 (the elements corresponding to the ones shown in the FIG. 2 are denoted with the same references, and their explanation will be omitted for the sake of brevity). In this case, the JRE 205 includes a customized class loader 310 that can be configured to operate in the production mode or in the test more; the configuration of the class loader 310 is defined by the value of a flag, which is stored in a corresponding file 320.

The class loader 310 obtains the definition of the classes MyClass1 235 and MyClass2 240 from the corresponding files 220. When the class loader 310 is configured to run in the production mode, this definition is used to instantiate the corresponding objects as usual.

Conversely, when the class loader 310 is configured to run in the test mode, the definition of each method of any loaded class is updated by inserting the invocation of the method Filter( ) of the class Handler 260 at its beginning. The definition of the class so updated is then used to instantiate the corresponding objects.

In this case, the application 225 includes the original class Factory (denoted with 230o), with the method GetMyClass1( ) and the method GetMyClass2( ) that always instantiate the class MyClass1 235 and the class MyClass2 240, respectively. However, the methods MyMethod1( ) and MyMethod2( ) of the respective classes MyClass1 235 and MyClass2 240 can now invoke (when updated by the class loader 310) the method Filter( ) that is exposed by the class Handler 260 before the execution of their actual code.

Therefore, the updated methods of each class implement (auxiliary) methods that are used to intercept any invocation of the corresponding (original) methods; each auxiliary method then invokes the corresponding original method or simulates the desired error condition when required. Even in this case, the auxiliary methods are built automatically at run-time without any manual intervention. However, the proposed approach does not require any modifications to the application; therefore, it is well suited to be used even for instrumenting pre-existing applications. Moreover, this technique applies to any kind of classes and/or methods (i.e., even to final classes and static methods).

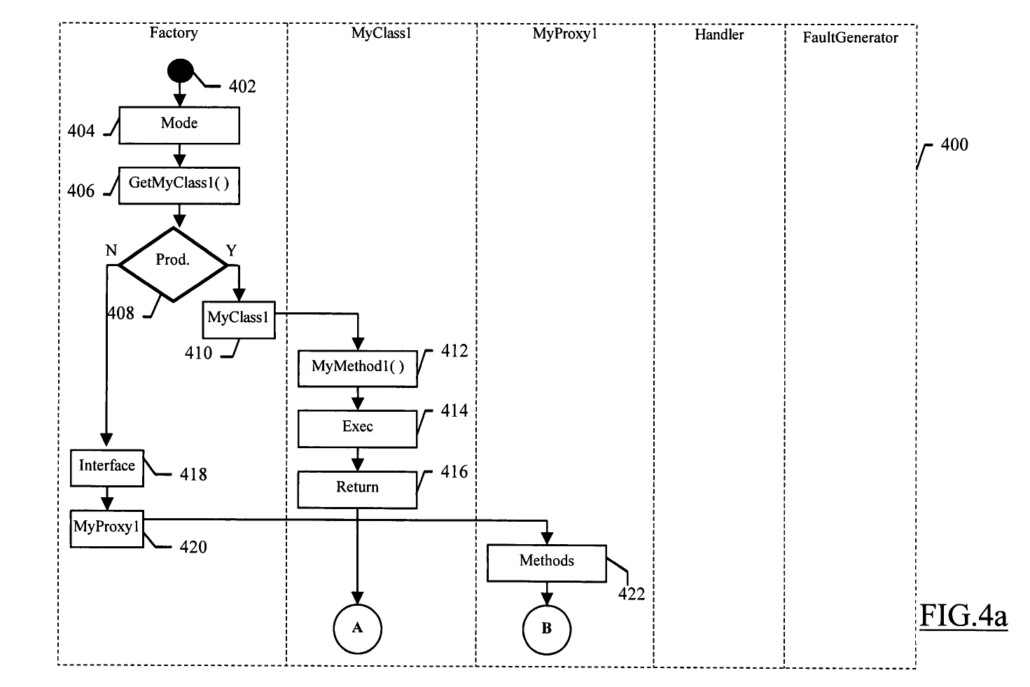

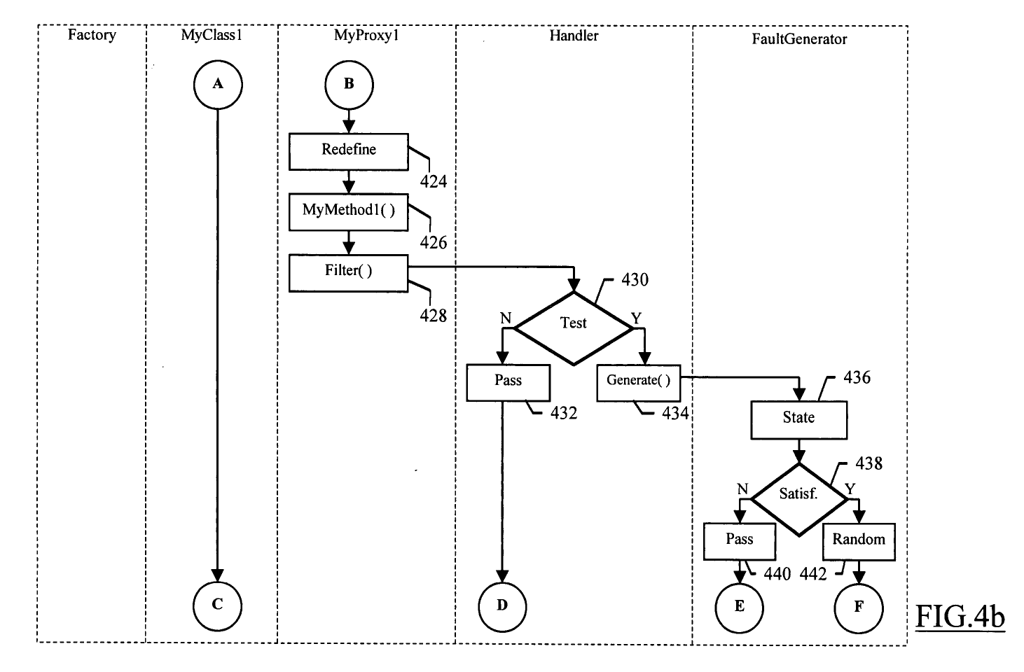

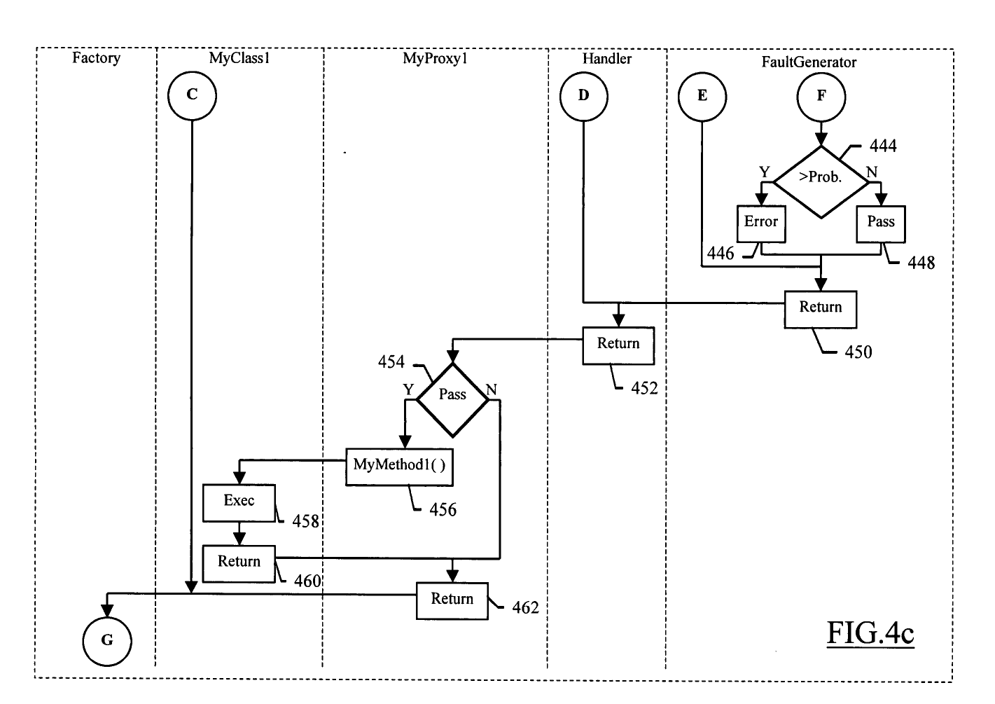

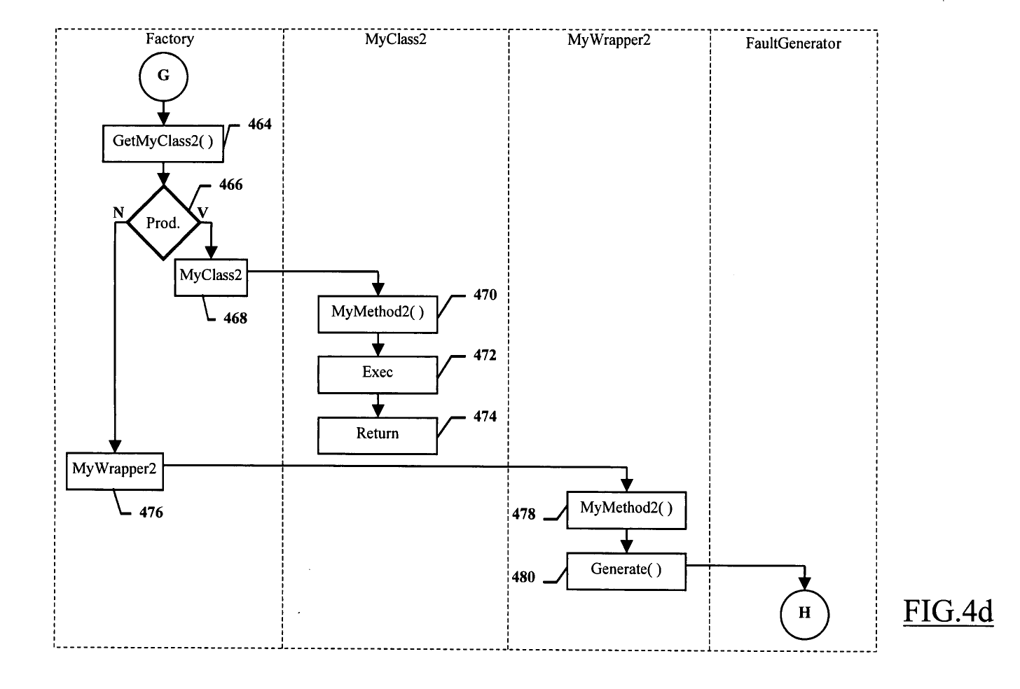

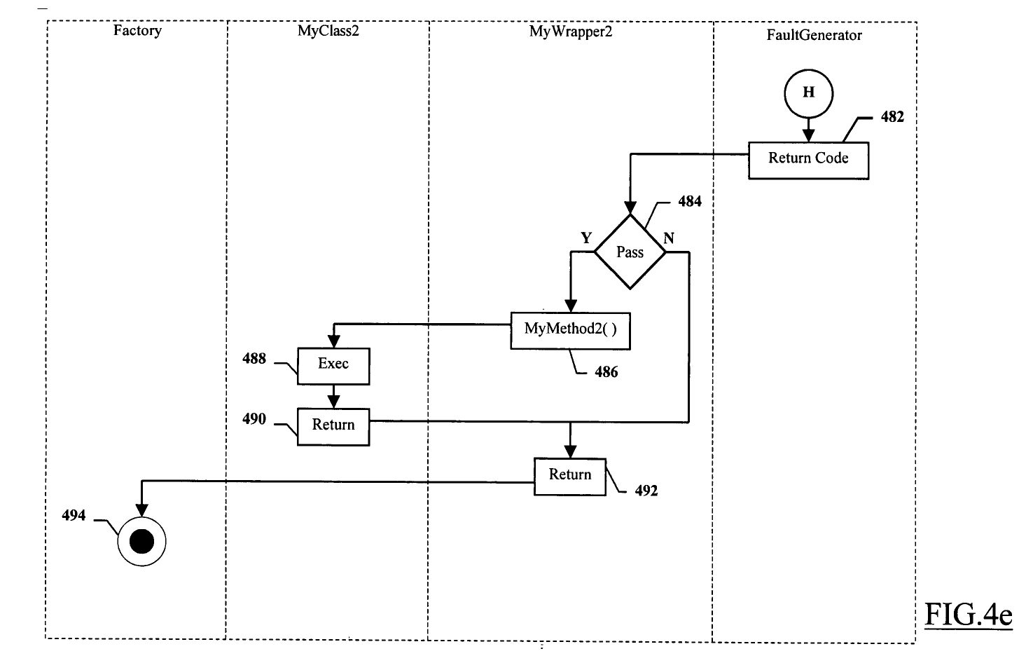

Considering now FIGS. 4a-4e, the logic flow of a test process implemented by the first embodiment of the invention (shown in the FIG. 2) is represented with a method 400. For example, let us assume that the above-described application involves the instantiation of an object for the class MyClass1 followed by the invocation of the method MyMethod1( ), and then the instantiation of an object for the class MyClass2 followed by the invocation of the method MyMethod2( ).

In this case, the process begins at the black start circle 402 in the swim-lane of the object instantiating the class Factory. Passing to block 404, the object Factory determines the operative mode of the application (according to the value of the attribute Mode of the object instantiating the class Configurator). With reference now to block 406, the method GetMyClass1( ) is called on the object Factory. The flow of activity branches at block 408 according to the operative mode of the application. Particularly, if the application is configured in the production mode the blocks 410-416 are executed, whereas if the application is configured in the test mode the blocks 418-462. are executed; in both cases, the method then merges at block 464.

Considering now block 410 (production mode), the method GetMyClass1( ) directly instantiates the class MyClass1. Moving to the swim-lane of the object MyClass1, the method MyMethod1( ) is invoked at block 412 (by another object). The corresponding operations are then executed at block 414. The process continues to block 416, wherein the code indicating the result of the execution of the method MyMethod1( ) is returned to the invoking object.

With reference instead to block 418 (test mode), the method GetMyClass1( ) determines the interface MyInterface1 that is implemented by the class MyClass1 (through an introspection process). Proceeding to block 420, the method GetMyClass1( ) identifies (through the corresponding attribute Association) and then instantiates the class MyProxyl. Moving now to the swim-lane of the object MyProxy1, the methods declared by the corresponding interface MyInterface1 (i.e., the method MyMethod1( ) in the example at issue) are determined at block 422 (through an introspection process). The process continues to block 424, wherein the object MyProxy1 redefines those methods as required.

The method MyMethod1( ) is now invoked on the object MyProxy1 at block 426 (by another object). In this case, the method MyMethod1( ) at block 428 invokes the method Filter( ) on the object instantiating the class Handler (passing the name of the class MyClass1 and the name of the method MyMethod1). Moving now to the swim-lane of the object Handler, the flow of activity branches at block 430 according to whether the method MyMethod1( ) must be instrumented or not for the test (as indicated in the corresponding attribute List). If not, the block 432 is executed, whereas on the contrary the blocks 434-450 are executed; in both cases, the method merges at block 452.

Considering in particular block 432 (method not to be tested), the return code is set to the pass value. With reference instead to block 434 (method to be tested), the handler invokes the method Generate( ) on the object instantiating the class FaultGenerator (relaying the name of the class MyClass1 and the name of the method MyMethod1). Passing to block 436 in the swim-lane of the object FaultGenerator, the state of the application stored in the corresponding attribute AppState is updated accordingly, for example, by incrementing a counter indicating the number of invocations of the method MyMethod1( ).

A test is then made at block 438 to determine whether the predefined condition for the simulation of the errors is satisfied (for example, because the method MyMethod1 has been already invoked for a number of times higher than the corresponding threshold value). If not, the block 440 is executed, whereas on the contrary the blocks 442-448 are executed; in both cases the flow of activity passes to block 450.

Considering now block 440 (condition not satisfied), the return code is set to the pass value. With reference instead to block 442 (condition satisfied), a random number between 0 and 1 is generated. A test is made at block 444 to determine whether the random number reaches the predefined probability of the desired error condition. If so, the return code is set to the corresponding error value at block 446. Conversely, the return code is set to the pass value at block 448. In both cases, the flow of activity then descends into block 450.

The code so determined is now returned at block 450 from the object FaultGenerator to the object Handler. The object Handler in turn relays the same return code to the object MyProxy1 at block 452. Moving now to the swim-lane of the object MyProxy1, the flow of activities branches at block 454 according to the value of the received return code. Particularly, if the return code has the pass value the object MyProxyl at block 456 invokes the method MyMethod1( ) on the object MyClass1. The corresponding operations are then executed at block 458. The process continues to block 460, wherein the code indicating the result of the execution of the method MyMethod1( ) is returned from the object MyClass1 to the object MyProxy1. The flow of activity then continues to block 462. The same point is also reached from block 454 directly when the received return code has the error value. Considering now block 462, the return code so obtained (from the object Handler or from the object MyClass1) is returned to the invoking object.

With reference now to block 464, the method GetMyClass2( ) is called on the object Factory. The flow of activity branches again at block 466 according to the operative mode of the application. Particularly, if the application is configured in the production mode the blocks 468-474 are executed, whereas if the application is configured in the test mode the blocks 476-492 are executed; in both cases, the method then ends at the concentric white/black stop circles 494.

Considering now block 468 (production mode), the method GetMyClass2( ) directly instantiates the class MyClass2. Moving to the swim-lane of the object MyClass2, as in preceding case the method MyMethod2( ) is invoked at block 470, the corresponding operations are executed at block 472, and the code indicating the result of the execution is returned to the invoking object at block 474.

With reference instead to block 476 (test mode), the method GetMyClass2( ) instantiates the corresponding class MyWrapper2. Moving now to the swim-lane of the object MyWrapper2, the method MyMethod2( ) is now invoked at block 478 (by another object). In this case, the method MyMethod2( ) invokes the method Generate( ) on the object FaultGenerator at block 480 (passing the name of the class MyClass2 and the name of the method MyMethod2). Continuing to block 482 in the swim-lane of the object FaultGenerator, the corresponding return code is determined (by executing the same operations described above at blocks 436-450) and returned to the object MyWrapper2.

The flow of activities branches at block 484 (in the swim-lane of the object MyWrapper2) according to the value of the received return code. Particularly, as in the preceding case, if the return code has the pass value the object MyWrapper2 invokes the method MyMethod2( ) on the object MyClass2 at block 486, the corresponding operations are executed at block 488, and the code indicating the result of the execution is returned to the object MyWrapper2 at block 490; the flow of activity then continues to block 492. The same point is also reached from block 484 directly when the received return code has the error value. Considering now block 492, the return code so obtained (from the object FaultGenerator or from the object MyClass2) is returned to the invoking object, and the process ends at the circles 494.

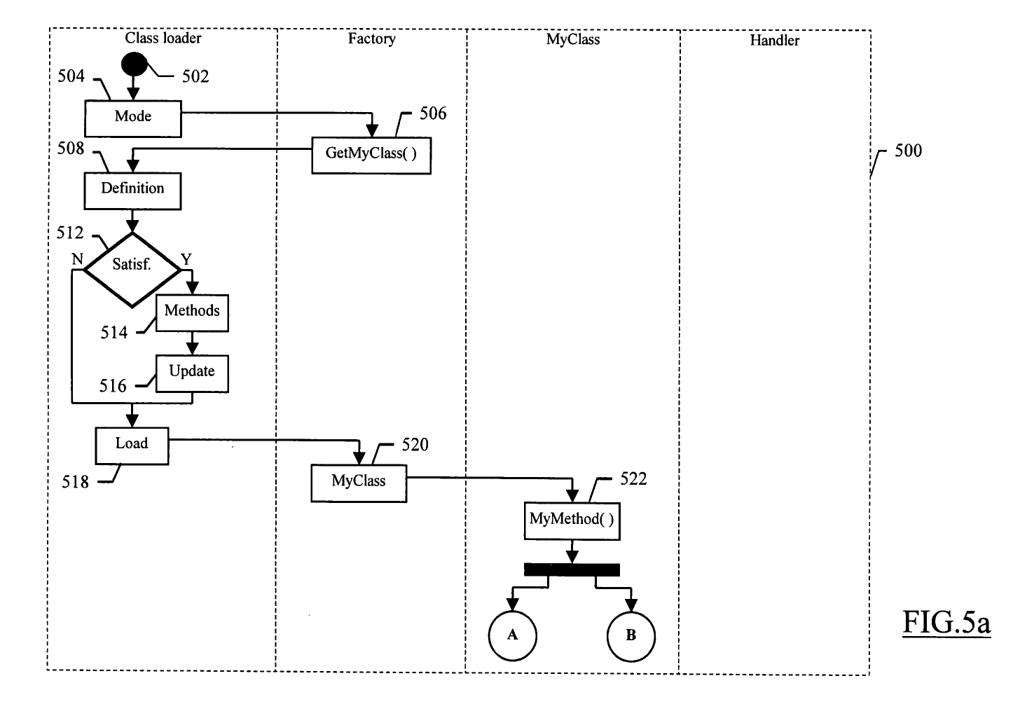

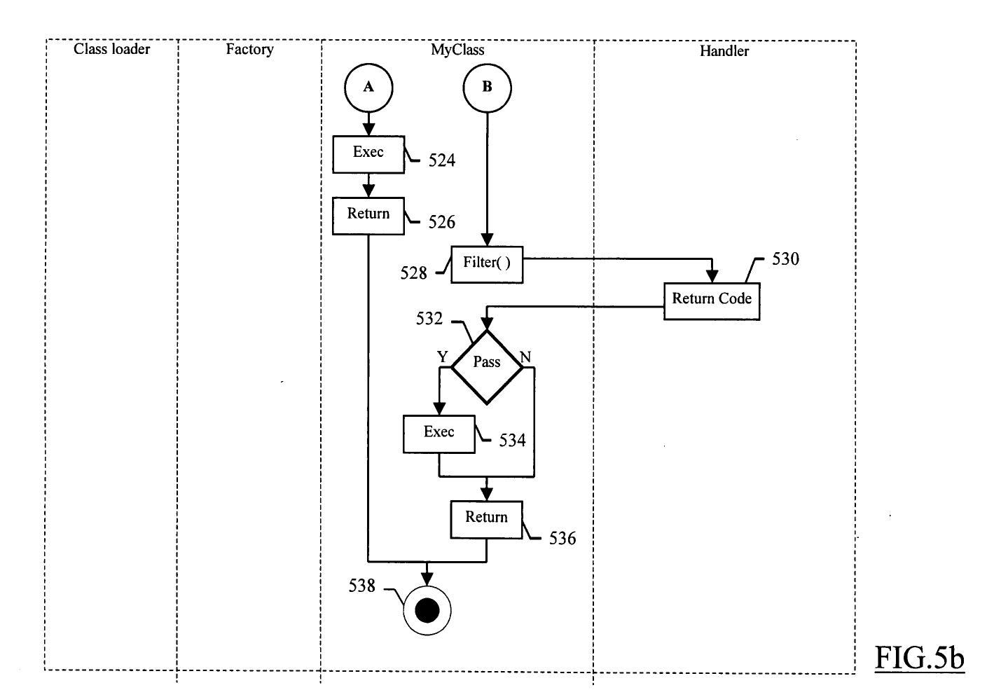

Moving to FIGS. 5a-5b, the logic flow of the test process implemented by the second embodiment of the invention (shown in the FIG. 3) is represented with a method 500. The method begins at the black start circle 502 in the swim-lane of the class loader. Passing to block 504, the class loader determines whether it is configured to operate in the production mode or in the test mode (according to the value of the corresponding flag). With reference now to block 506, a generic method GetMyClass( ) for instantiating any new class of the application (i.e., corresponding to the method GetMyClass1( ) or the method GetMyClass2( ) in the example at issue) is called on the object Factory. The execution of the method GetMyClass( ) involves the request to the class loader of providing the code of the desired class, generically denoted with MyClass (i.e., corresponding to the class MyClass1 or the class MyClass2 in the example at issue).

Returning to the swim-lane of the class loader, the definition of the class MyClass is read at block 508 from the corresponding file. The flow of activity now branches at block 512 according to the operative mode of the class loader. Particularly, if the class loader is configured in the test mode the methods exposed by the class MyClass (i.e., the method MyMethod1( ) for the class MyClass1 or the method MyMethod2( ) for the class MyClass2 in the example at issue) are determined at block 514 (through an introspection process). Proceeding to block 516, the class loader updates each method by inserting the invocation of the method Filter( ) on the object Handler at its beginning. The process then continues to block 518. The same point is also reached from block 512 directly when the class loader is configured in the production mode.

With reference now to block 518, the code of the class MyClass so obtained is returned to the object Factory. A new object instantiating the class MyClass is then created at block 520. A generic method exposed by the object MyClass (denoted with MyMethod( )) is invoked at block 522. In this case, the process forks into two branches that are executed alternatively according to the configuration of the class loader. A first branch corresponding to the production mode consists of blocks 524-526, and a second branch corresponding to the test mode consists of blocks 528-536; the two branches joint at the concentric white/black stop circles 538.

Considering in particular block 524, in the production mode the operations required by the (original) method MyMethod( ) are executed at block 524. The process continues to block 526, wherein the code indicating the result of the execution of the method MyMethod( ) is returned to the invoking object.

With reference instead to block 528, in the test mode the (updated) method MyMethod( ) invokes the method Filter( ) on the object Handler. Continuing to block 530 in the swim-lane of the object Handler, a corresponding return code is determined (by executing the same operations described above at blocks 430-452) and returned to the object MyClass. The flow of activity branches at block 532 (in the swim-lane of the object MyClass) according to the value of the received return code. Particularly, if the return code has the pass value the operations of the (original) method MyMethod( ) are executed at block 534; the process then descends into block 536. The same point is also reached from block 532 directly when the received return code has the error value. Considering now block 536, the return code so obtained (from the object Handler or from the actual execution of the method) is returned to the invoking object, and the process ends at the circles 538.

The above-described solution can also be seen as an application of the Aspect Oriented Programming (AOP) paradigm. As it is well known, the AOP is based on the identification of any relevant issue (or concern) of each application; some concerns (called crosscutting concerns) tend to affect multiple functional modules of the application. In the AOP, each crosscutting concern is implemented individually; a specific module (called weaver) is then used to recompose the application, thereby distributing the implementation of the different crosscutting aspects throughout the functional modules of the application. This avoids tangling the code of the functional modules with instructions for a multitude of purposes. With reference to the specific example at issue, in the proposed solution the test aspect is implemented by the objects Handler and FaultGenerator; the operation of those objects is then integrated into the application by means of the proxy and wrapper objects, or by means of the class loader.

Naturally, in order to satisfy local and specific requirements, a person skilled in the art may apply to the solution described above many modifications and alterations. Particularly, although the present invention has been described with a certain degree of particularity with reference to preferred embodiment(s) thereof, it should be understood that various omissions, substitutions and changes in the form and details as well as other embodiments are possible; moreover, it is expressly intended that specific elements and/or method steps described in connection with any disclosed embodiment of the invention may be incorporated in any other embodiment as a general matter of design choice.

For example, even though in the preceding description reference has been made to the Java language, this is not to be intended as a limitation (with the solution of the invention that can be applied to applications written in any other language supporting the concepts of equivalent objects and methods). Similar considerations apply if the operative mode of the application is selected by setting an equivalent indicator, if the application includes a different number of objects (each one exposing any number of methods), or if other return codes are supported; for example, it is possible to have the method Generate( ) simulate different error conditions alternatively (according to corresponding probabilities).

In any case, without departing from the principles of the invention, each proxy object or the customized class loaded can instrument only some selected methods of each class (for example, listed in a corresponding configuration file).

Besides, more complex filter policies for the instrumentation of the desired methods are contemplated (for example, to enable the test of some methods only when they are invoked by selected objects).

The process of the invention leads itself to be implemented even with policies based on other state information of the application (for example, defined by more complex relationships among its components) and/or other probabilities of the error conditions (for example, defined by their mean values and standard deviations).

Similar considerations apply if the programs are structured in a different way, or if additional modules or functions are provided; likewise, the different memory structures can be of different types, or can be replaced with equivalent entities (not necessarily consisting of physical storage media). Moreover, the proposed solution can implement equivalent methods (for example, with similar or additional steps).

In any case, it is possible to distribute the programs in any other computer readable medium (such as a DVD).

Alternatively, the concepts of the present invention are also applicable when the computer has a different architecture or is based on equivalent elements; likewise, the computer can be replaced with any data processing entity (such as a PDA, a mobile phone, and the like).

Moreover, it will be apparent to those skilled in the art that the additional features providing further advantages are not essential for carrying out the invention, and may be omitted or replaced with different features.

For example, it is possible to implement the proposed solution even without a specific fault generator object.

In addition, an implementation that does not support any handler object (for filtering the methods to be instrumented for the test) is feasible.

The solution of the invention leads itself to be practiced even with the proxy objects or the wrapper objects only, and in applications that do not have any factory object.

In any case, the principles of the present invention should not be limited to the above-described preferred implementations (based on the proxy objects, the wrapper objects or the class loader); indeed, the same concepts apply to any other technique for enabling a corresponding auxiliary method in substitution of one or more selected methods of the application.

Without departing from the solution of the invention, the error conditions can be simulated according to policies based on the state information or the probabilities only; alternatively, the use of other criteria (for example, based on fuzzy logic rules) is contemplated.

Similar considerations apply if the programs are pre-loaded onto the hard disk, are sent to the computer through the network, are broadcast, or more generally are provided in any other form directly loadable into the working memory of the computer.

At the end, the method according to the present invention leads itself to be carried out with a hardware structure (for example, integrated in a chip of semiconductor material), or with a combination of software and hardware.

1. A process for testing a software application including a plurality of objects each one exposing at least one method, the process including the steps of:
selecting a production mode or a test mode of the application,
enabling a corresponding auxiliary method in substitution of at least one selected method in the test mode, and
in response to the invocation of each method executing the method and in response to the invocation of each auxiliary method executing the corresponding selected method or simulating an error condition according to a predefined policy.

2. The process according to claim 1, wherein the step of executing the selected method or simulating the error condition includes:
the auxiliary method causing the invocation of a generation method exposed by a fault generator object,
the generation method returning a first code having a pass value or an error value indicative of the error condition according to the policy,
the auxiliary method invoking the selected method in response to the pass value, and
the auxiliary method returning the first code in response to the error value or a second code indicative of a result of the selected method in response to the pass value.

3. The process according to claim 2, wherein the step of causing the invocation of the generation method includes:
the auxiliary method invoking a filter method exposed by a handler object,
the filter method preventing or allowing the invocation of the generation method according to a further predefined policy.

4. The process according to claim 1, wherein each object instantiates a class defining the corresponding at least one method, for each object the step of enabling the auxiliary method in substitution of the at least one selected method including the operations under the control of a class loader of:
loading the corresponding class, and
updating each method defined by the class to implement the corresponding auxiliary method.

5. The process according to claim 1, wherein the application includes a factory object for instantiating the objects, for each first object implementing at least one predefined interface declaring the corresponding at least one method the step of enabling the auxiliary method in substitution of the at least one selected method including:
the factory object instantiating a corresponding proxy object for the first object, the proxy object implementing the at least one interface, and
the proxy object redefining each method declared by the at least one interface to implement the corresponding auxiliary method.

6. The process according to claim 5, wherein for each second object exposing at least one selected method and implementing no interface the step of enabling the auxiliary method in substitution of the at least one selected method includes:
the factory object instantiating a corresponding predefined wrapper object for the second object, the wrapper object extending the selected object by redefining each selected method exposed by the selected object to implement the corresponding auxiliary method.

7. The process according to claim 1, wherein the policy is based on state information of the application.

8. The process according to claim 1, wherein the policy is based on a predefined probability of the error condition.

9. (canceled)

10. A computer program product in a computer readable medium, the program being directly loadable into a working memory of a data processing system for performing a process for testing a software application when the program is run on the system, wherein the application includes a plurality of objects each one exposing at least one method, the process including the steps of:
selecting a production mode or a test mode of the application,
enabling a corresponding auxiliary method in substitution of at least one selected method in the test mode, and
in response to the invocation of each method executing the method and in reponse to the invocation of each method executing the method and in response to the invocation of each auxiliary method executing the corresponding selected method or simulating an error condition according to a predefined policy.

11. A data processing system for testing a software application including a plurality of objects each one exposing at least one method, the system including:
means for selecting a production mode or a test mode of the application, and means for enabling a corresponding auxiliary method in substitution of at least one selected method in the test mode, in response to the invocation of each method the method being executed and in response to the invocation of each auxiliary method the corresponding selected method being executed or an error condition being simulated according to a predefined policy.

12. The system as recited in claim 11 wherein the enabling is a proxy object.

13. The system as recited in claim 11 is a class loader.
